(19) United States
(12) Patent Application Publication
(10) Pub. No.: US 2023/0230595 A1
(43) Pub. Date: Jul. 20, 2023

(54) SIDEBAR ASSISTANT FOR NOTETAKING IN SIDEBARS DURING VIRTUAL MEETINGS

(71) Applicant: Zoom Video Communication, Inc., San Jose, CA (US)

(72) Inventor: Patrick Baird, Arvada, CO (US)

(73) Assignee: Zoom Video Communication, Inc., San Jose, CA (US)

(21) Appl. No.: 17/577,686

(22) Filed: Jan. 18, 2022

(51) Int. Cl. G10L 15/26; G10L 15/18; H04L 12/18

(52) U.S. Cl. CPC G10L 15/26; G10L 15/1815; H04L 12/1831; H04L 12/1822

(57) ABSTRACT

Provided herein are systems and methods for providing a sidebar assistant for sidebars during virtual meetings. A system may include a non-transitory computer-readable medium, a communications interface, and a processor communicatively coupled to the non-transitory computer-readable medium and the communications interface. The processor may be further configured to establish a video conference having a plurality of participants, receive, from a first client device, a request for a sidebar meeting, and transmit to the first client device a first set of audio and video streams corresponding to a main meeting, and a second set of audio and video streams corresponding to the sidebar meeting. The processor-executable instructions may further cause the processor to identify, by a sidebar assistant, one or more keywords in an audio stream corresponding to the sidebar meeting and generate, by the sidebar assistant, a note based on the identified keywords.

### FIELD

The present application generally relates to videoconferences and more particularly relates to systems and methods for providing notetaking functionality for a sidebar during a virtual meeting.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1, 2, and 3A-3B show example systems for providing a sidebar meeting during a virtual meeting, according to an embodiment herein;

FIG. 4 shows an example of a sidebar assistant that may be executed by a client device for providing notetaking functionality during a sidebar meeting, according to an embodiment herein;

FIG. 5 illustrates an example notification confirming the function identified by a sidebar assistant, according to an embodiment herein; and

FIG. 6 illustrates an graphical user interface for a participant in a sidebar meeting, according to an embodiment herein;

FIG. 7 illustrates a graphical user interface for a participant in a main meeting, according to an embodiment herein;

FIG. 8 depicts an exemplary method for providing a sidebar assistant during a sidebar meeting, according to an embodiment herein;

FIG. 9 depicts another exemplary method for providing a sidebar assistant during a sidebar meeting, according to an embodiment herein; and

FIG. 10 shows an example computing device suitable for providing sidebar assistant functionality during a sidebar meeting, according to this disclosure.

### DETAILED DESCRIPTION

Examples are described herein in the context of systems and methods for providing sidebar assistant functionality in a sidebar meeting during a virtual meeting. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Video conference providers can enable people to interact with each other using their own computers (or “client devices”) with both video and audio in a variety of settings, such as in one-on-one conversations, group meetings, and webinars. While each of these types of settings can allow people to interact with each other, they can differ in character. For example, one-on-one conversations include only two people and may involve only a small amount of data being transmitted between the two client devices. Group meetings may involve a larger number of people all interacting with each other. In contrast, webinars typically involve a group of people that are attending to hear presentations from one or more presenters. Thus, in a webinar, interaction tends to be mostly one-way: from the presenter(s) to the audience.

During both webinars and conventional virtual meetings, one or more participants may want to engage in side conversations or interactions without interrupting the main presentation. For example, during a virtual meeting a participant may want to ask another participant a question about the presentation topic or discuss the presentation topic in further detail with the other participant without interrupting the main presentation. During a physical meeting, these participants may be able to whisper to each other during a presentation to communicate without interrupting the meeting. In the virtual space, however, engaging in a side conversation or whispering to a neighbor participant during a meeting is not feasible.

To allow participants to engage in a side conversation or a sidebar without interrupting the main presentation or disrupting the attention of other participants in the virtual meeting, a sidebar meeting may be provided. A sidebar meeting may be a separate channel in which two or more participants (“sidebar participants”) can communicate with each other without disrupting the main meeting. For example, only the participants in the sidebar meeting may receive audio and video streams from other participants in the sidebar meeting, along with the audio and video streams from the main meeting. The remaining participants in the main meeting would not receive the audio and video streams from the participants in the sidebar meeting, thus allowing the main meeting to continue without disruption from the sidebar meeting.

A sidebar meeting can allow participants to discuss action items or highlight topics discussed in the main meeting. Often participants may desire to take note of action items or topics of interest as they arise during the main meeting. Physically taking notes, however, may detract from the participant's focus of the main meeting. The distraction may be further amplified by the participant's involvement in a sidebar meeting during a main meeting. Accordingly, to assist a participant in keeping track of action items or topics of interest, while in a sidebar during a virtual meeting, a notetaking functionality is provided.

To provide participants in a sidebar meeting notetaking functionality, a sidebar assistant may be provided. A sidebar assistant may monitor the audio streams from the sidebar meeting for action items, notes, or snippets to record. In some examples, the sidebar assistant may monitor the audio streams exchanged in the sidebar meeting for a keyword or phrase requesting invocation of the notetaking functionality. For example, the sidebar assistant may monitor the sidebar meeting for a request to add a task to an action item list.

When the sidebar assistant identifies a keyword invoking the notetaking functionality, the sidebar assistant may analyze the context of the keyword to determine which action of the notetaking functionality to perform. For example, some keywords may indicate that the sidebar assistant should add a task to an action item list, other keywords may indicate that the sidebar assistant should transcribe and add to the notes the spoken words following the keyword, while still other keywords may indicate that the sidebar assistant should record a snippet of the main meeting. The action item list (“task note(s)”), transcription of the spoken word (“note(s)”), and/or snippet of the main meeting (“recording note”) may be added to the ‘notes’ of the sidebar meeting (“sidebar notes”) by the sidebar assistant.

In some embodiments, the sidebar notes may be displayed to a participant in the sidebar meeting (“sidebar participant”). A sidebar participant may be able to see the sidebar notes as the sidebar assistant adds them. This may allow the sidebar participant to review the notes as they are generated and, in some examples, edit the sidebar notes. For example, the sidebar participant may add additional comments to an action item or edit the spelling of a name that was transcribed by the sidebar assistant.

After a sidebar meeting is terminated, the sidebar notes may be shared and/or sent to the sidebar participants. This may provide the sidebar participants with the sidebar notes generated by the sidebar assistant during the sidebar meeting. The sidebar assistant may provide a participant the ability to take notes during a sidebar meeting with minimal input and have, upon termination of the sidebar meeting, notes from the meeting for review. Unlike a recording of a virtual meeting, the sidebar assistant only generates notes of specific items from the sidebar conversation. This can allow for the sidebar notes to only encompass aspects from the sidebar meeting that a participant finds important or necessary. Additionally, because the sidebar meeting is only recorded or transcribed upon invocation of the sidebar assistant, the sidebar meeting can flow freely without participants being concerned that the entire conversation is being recorded.

This illustrative example is given to introduce the reader to the general subject matter discussed herein and the disclosure is not limited to this example. The following sections describe various additional non-limiting examples and examples of systems and methods for providing a sidebar assistant for a sidebar meeting during a videoconference.

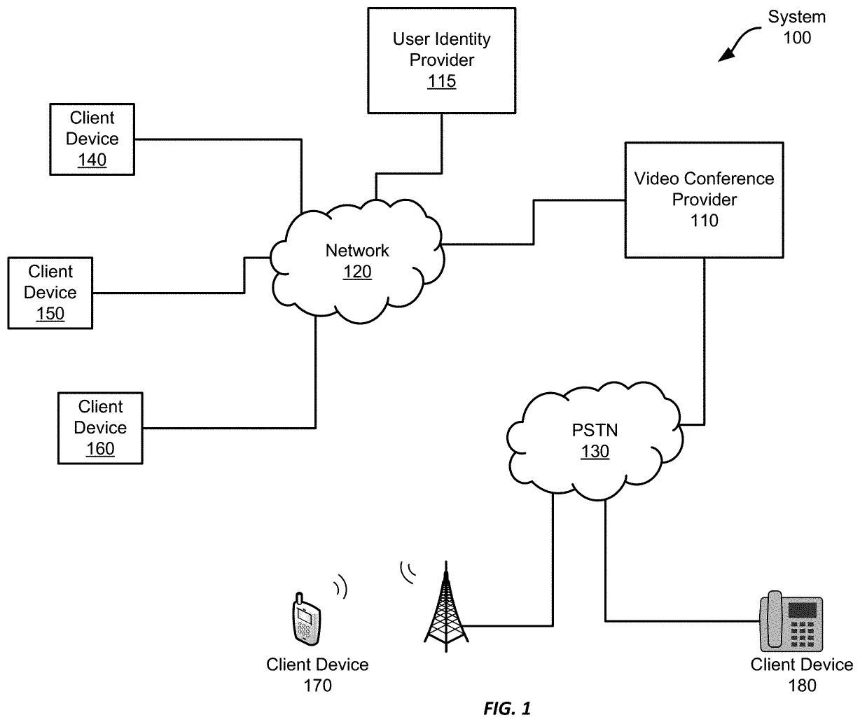

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the video conference provider 110 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

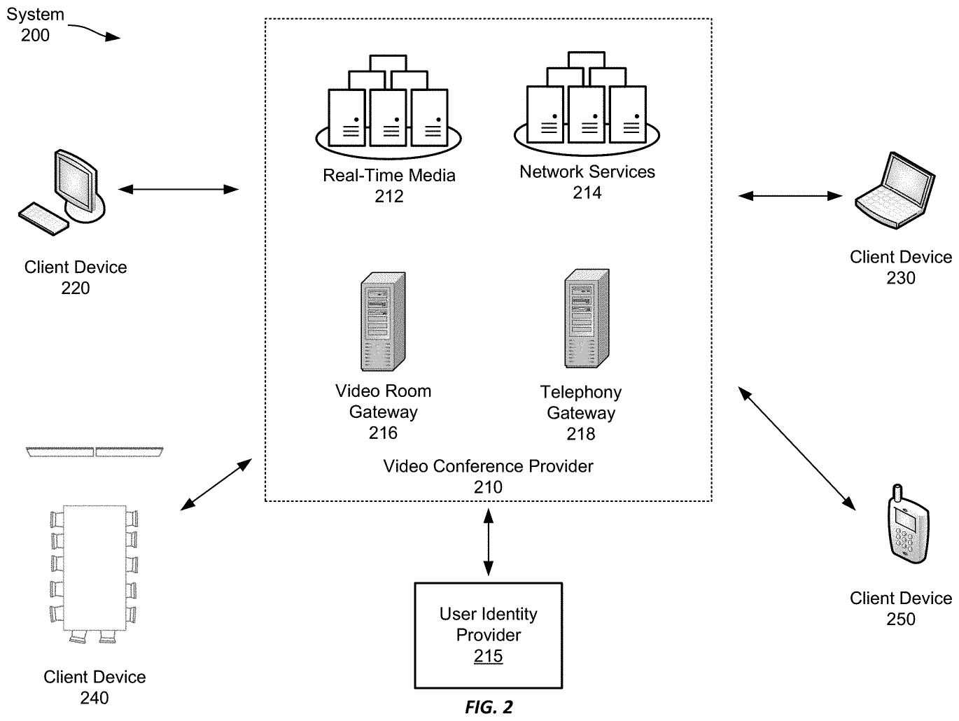

Video conference provider 110 allows clients to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “a sidebar meeting”. A sidebar meeting as provided herein may be a “room” that is associated with a “main” videoconference room or “main meeting”. Thus, participants who wish to engage in a sidebar conversation during the main videoconference may enter a sidebar virtual room to engage in a sidebar conversation, e.g., to discuss a particular topic, before returning to the main meeting.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode. As discussed in detail below, in some embodiments, the sidebar meeting may terminate, thereby disconnecting only participants in that sidebar meeting. The main meeting may continue allowing participants therein to continue exchanging audio and video streams.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can making conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different Examples of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference system 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a sidebar meeting, such a command may also be handled by a network services server 214, which may terminate the authorization of the one or more participants for joining the sidebar meeting. In some examples, the host may wish to join one or more participants in a sidebar meeting. The command to do so may be handled by a network services server 214, which may provide authorization information to the one or more participants to join the sidebar meeting and then connect the one or more participants to the sidebar meeting similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

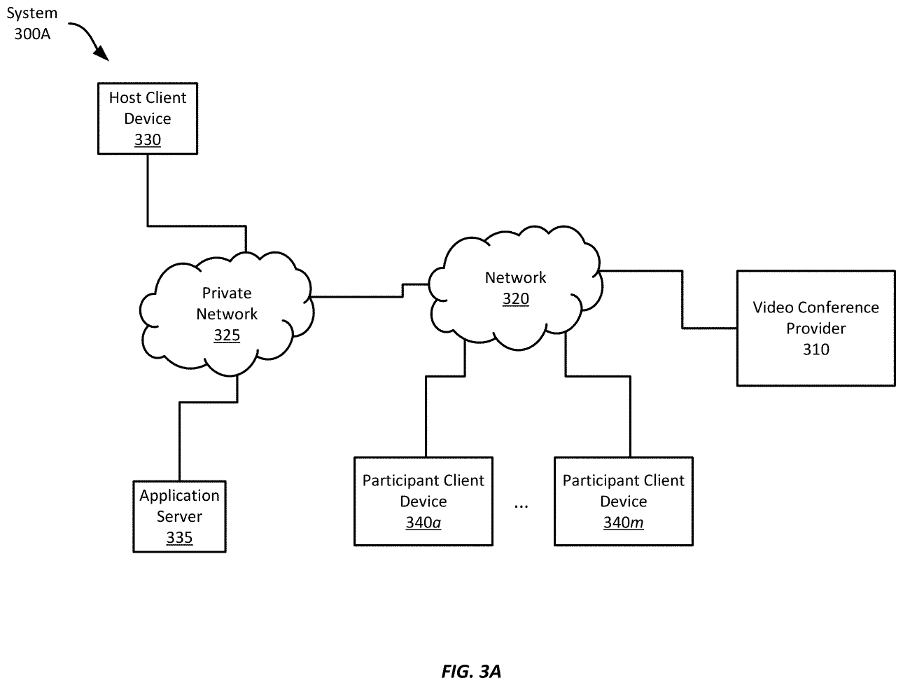

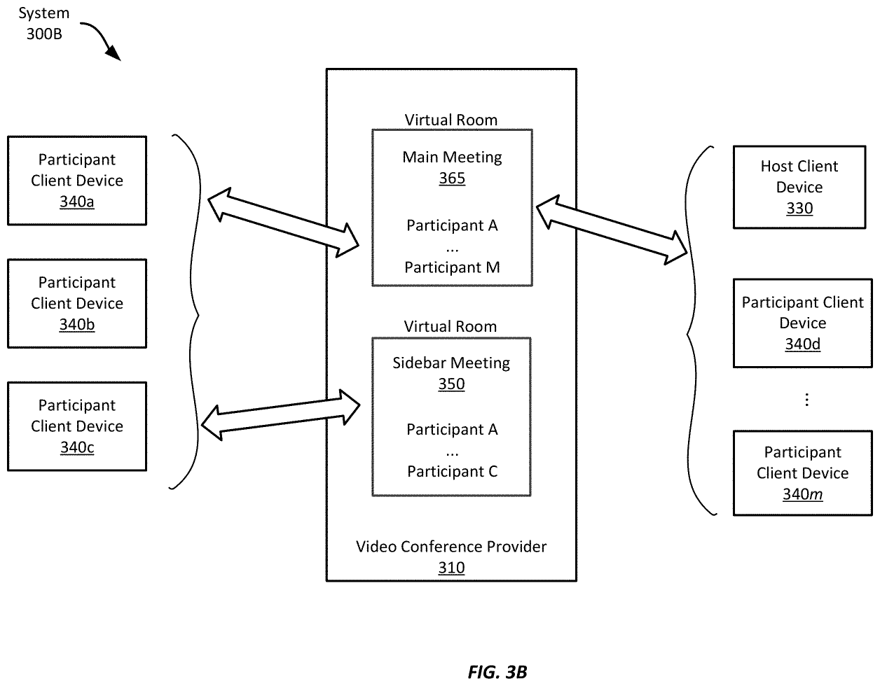

Referring now to FIG. 3A, FIG. 3A shows an example system 300 for providing a sidebar meeting during a main meeting. In this example, a video conference provider 310 provides video conference services to multiple different client devices 330 and 340a-m, generally as described above with respect to FIGS. 1 and 2. In this example, the client devices 330 and 340a-m participate in a meeting hosted by the video conference provider 310. Client devices 340a-m connect to the video conference provider 310 over a public network 320, e.g., the internet; however, host client device 330 participates from within a private network 325, such as from their office at work. In addition to the host client device 330, an application server 335 is connected to the private network and makes various business applications available to the host client device 330. In different examples, these business applications may vary; however, in this example, the application server 335 provides applications to access business databases and files. To access these various resources, the host client device 330 has different client applications installed on it and may also have web applications accessible via a web browser, which may be stored as bookmarks in the web browser.

To start a meeting, the host client device 330 connects to the video conference provider 310 and begins a main meeting (“meeting”) at the video conference provider 310, such as by beginning a scheduled meeting, generally as described above with respect to FIGS. 1 and 2. The video conference provider 310 may create and manage the meeting as discussed above.

Once the main meeting is started, participants may be able to interact with other participants and see their respective names, such as in close proximity to other participants' video streams or in a list of participants visible in a graphical user interface (“GUI”). In some embodiments, the participants may only be able to see information, e.g., names or video feeds, from the host(s) of the webinar or certain select participants that will be engaged in discussions during the main meeting, such as panelists in a panel discussion. Still other limits may be imposed on the various participants, such as their ability to react to occurrences during the meeting, e.g., participants may be allowed to interact with their GUI to raise their hand to ask a question, but may not be allowed to provide any other feedback.

During the meeting, a participant may wish to engage in a sidebar conversation with one or more other participants of the main meeting. If a sidebar meeting is initiated by a participant, as described in greater detail below, the video conference provider 310 may also host the sidebar meeting. Referring now to FIG. 3B, a system 300B for hosting a main meeting 365 including a sidebar meeting 350 is provided, according to an embodiment herein. The video conference provider 310 may establish a main meeting 365, which hosts the main meeting event. The main meeting 365 may be considered a virtual “room” in which participants of the main meeting can meet and communicate. Participants of the main meeting may have various types of roles. For example, there may be one or more host role(s) (e.g., the participant corresponding to host client device 330) and one or more attendee role(s) (e.g., participants corresponding to client devices 340a-340m). In some embodiments, such as a webinar example, there may also be a panelist role in the main meeting.

During the main meeting 365, the participants may receive audio and video streams exchanged during the main meeting 365. For example, if the host is presenting on a topic, the audio and video streams from the host client device 330 may be received by the client devices 340a-m. The main meeting 365 may be an interactive virtual space where the participants can also contribute to the main meeting event. As such, audio and video streams from the client devices 340a-m may also be exchanged during the main meeting 365.

During the main meeting 365, a participant, such as Participant A corresponding to the client device 340a, may want to engage in a sidebar conversation with other participants, such as Participants B and C corresponding to the client devices 340b and 340c. To initiate a sidebar meeting, and thereby allow a sidebar conversation to occur without interrupting the main meeting event, Participant A, via the client device 340a, may send a request to Participants B and C, via the client devices 340b and 340c. The request may be sent through video conference provider 310. When the client devices 340b and 340c accept the request, the video conference provider 310 may establish the sidebar meeting 350. The sidebar meeting 350 may be a virtual meeting space in which Participants A, B, and C can meet to exchange dialogue (e.g., multimedia streams) without interrupting the main meeting 365 and without leaving the main meeting 365.

When the Participant A establishes the sidebar meeting 350 with the participants B and C, the client devices 340a-c are able to exchange audio and video streams. Individuals who are not part of the sidebar meeting 350 (Participants D-M, the host(s), etc.), however, may not receive the audio and video streams from the client devices 340a-340c. Instead, as illustrated by FIG. 3B, the client devices 340d-340m and the host client device 330, may only receive the multimedia streams from the main meeting 365. In this manner, individuals in the main meeting 365 who are not part of the sidebar meeting 350 may be unaware that Participants A-C are engaged in a sidebar conversation.

Participants in the sidebar meeting 350, however, may continue to receive the audio and video streams from the main meeting 365 so that they do not miss any content presented during the main meeting 365 when engaging in the sidebar meeting 350. In the sidebar meeting 350, the client devices 340a-c may receive audio and video streams from both the main meeting 365 and the sidebar meeting 350. Participants in the sidebar meeting 350 are able to interact with the other participants in the sidebar meeting 350, such as by providing audio and video feeds and receiving audio and video feeds from other sidebar participants. Participants in the sidebar meeting 350, however, cannot interact with participants in the main meeting 365. In other words, participants in the sidebar meeting 350 can talk and share content with each other in the sidebar meeting 350 without attendees of the main meeting 365 being involved.

In some embodiments, the sidebar meeting 350 may only include audio. For example, the Participant A may want to briefly say something to Participants B and C, analogous to whispering a comment to a coworker during a work meeting in the physical world. To do so, the Participant A may select an option to engage in an audio-only sidebar meeting with the Participants B and C. An audio-only sidebar meeting may be the same as the sidebar meeting 350, except that no video streams would be exchanged between the client devices 340a-c; only an audio stream would be exchanged between the client devices 340a-c. While in the audio-only sidebar meeting, the client devices 340a-c may receive the audio and video streams from the main meeting 365 and an audio stream from the audio-only sidebar meeting. The audio streams from the client devices 340a-c in the audio-only sidebar meeting, similar to participants in the sidebar meeting 350, may only be received by the client devices 340a-c, so as to not disrupt the main meeting 365.

While in the sidebar meeting 350, the Participants A-C can readily return to the main meeting 365 as desired. In some embodiments, the video streams from the client devices 340a-c, when in the sidebar meeting 350, may continue to be received by the other participants in the main meeting 365. In other embodiments, when the client devices 340a-c join the sidebar meeting 350, the participants in the main meeting may no longer receive the video streams from the client devices 340a-c while the Participants A-C are in the sidebar meeting 350 and instead may see only a stylized silhouette of a person's head and shoulders or another icon, graphic, or text to represent the participant while they are in the sidebar meeting.

Depending on the role of a particular participant in the main meeting, various restrictions may apply. A host may have little to no restrictions. The level of restrictions for a host role may be set by the video conference provider 310 or by the host. In cases where there is a co-host or more than one host role, hosts may have varying levels of restrictions. For example, a main host (e.g., the host who arranged the main meeting) may be running late and assign another participant the role of co-host to begin the main meeting on time. The main host may also assign various restrictions to the co-host, such as not allowing the co-host to change the roles of other participants.

The host may also be able to authorize a participant to join the sidebar meeting 350 or may terminate a sidebar meeting 350. For example, the host may receive a notification that the sidebar meeting 350 is established. This may allow the host to monitor the participants and in the event that the Participants A-C become disruptive due to their participation in the sidebar meeting 350, the host can terminate the sidebar meeting 350. In another example, the host may request to join a participant, such as participant D, to the sidebar meeting 350. Upon initiation of the sidebar meeting 350, the host may receive an indication of what participants are part of the sidebar meeting 350. The host may realize that participant D should also be part of the sidebar meeting 350, and as such, request to add client device 340d to the sidebar meeting 350.

In other embodiments, however, the host may have no indication that a sidebar meeting 350 is established. By not providing an indication of the sidebar meeting 350 to the host, this may allow the sidebar meeting 350 to be as minimally disruptive to the main meeting 365 as possible. It may also allow participants to freely enter and exit a sidebar meeting 350 without concerns of disruption or recognition that they are engaging in a sidebar conversation.

It should be appreciated that more than one sidebar meeting 350 may be established during the main meeting 365. Any number of the sidebar meetings 350 may be established. Once a main meeting 365 has started, the participants may engage in any number of the sidebar meetings 350. Each participant, however, can only engage in a single sidebar meeting 350 at a time. The participant, though, can engage in consecutive sidebar meetings 350 throughout the duration of the main meeting 365. In embodiments where a participant is engaged in a sidebar meeting 350 and another participant requests the participant to engage in a different sidebar meeting, the other participant may receive a notification that the participant is in the sidebar meeting 350 and unavailable for a sidebar conversation. The participant in the sidebar meeting 350 may also receive a notification that the other participant requests a sidebar conversation. Upon receipt of the notification the participant can determine if he or she desires to exit the sidebar meeting 350 and enter another sidebar meeting with the other participant.

Any number of participants can be engaged in the sidebar meeting 350. For example, Participants A-F may wish to engage in a sidebar conversation. Upon request and acceptance by each of the Participants A-F to engage in the sidebar meeting 350, the video conference provider 310 may establish the sidebar meeting 350 and join the client devices 340a-f to the sidebar meeting 350 (not shown).

During the sidebar meeting, a sidebar assistant may be invoked. As will be described in greater detail below, the sidebar assistant may be invoked by one or more keywords or phrases. The sidebar assistant may monitor the audio streams from one or more participants in the sidebar meeting 350 for keyword(s) and/or phrase(s). After identifying the keyword(s) or phrase(s), the sidebar assistant may be invoked to perform one or more notetaking functions.

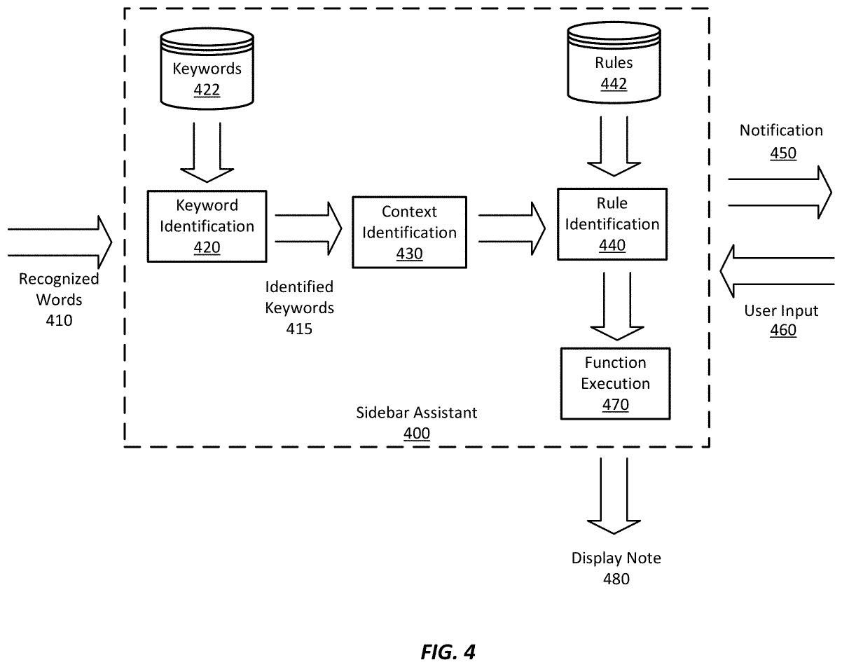

Turning now to FIG. 4, FIG. 4 illustrates an example of a sidebar assistant 400 that may be executed by a client device, such as client devices 340a-c, for providing notetaking functionality during a sidebar meeting. The following figures and related components, such as the sidebar assistant 400 of FIG. 4, will be described with respect to systems shown in FIGS. 3A-B, however, any suitable system according to this disclosure may be employed, such as those described in FIGS. 1 and 2.

The sidebar assistant 400 may receive recognized words 410 based on audio recorded by the client device's microphone. For example, when the Participant A speaks to the Participants B and C in the sidebar meeting 350, the Participant A's speech may be recorded by the microphone on the client device 340a as an audio stream. The audio stream may be analyzed via speech recognition to identify recognized words 410. Recognized words 410 may be based on an identified language of the Participant A's speech. In some embodiments speech recognition may be performed by the video conference provider 310, while in other embodiments speech recognition may be performed on the audio stream by a remote computing device, such as a cloud server dedicated to speech recognition. In still other embodiments, the speech recognition may be performed locally on the client device 340a.

Recognized words 410 from speech recognition may be input into the sidebar assistant 400 to identify one or more keywords 415. Once recognized words 410 have been received, the sidebar assistant 400 can perform keyword identification 420 using a database of keywords 422. It should be appreciated that in some examples, recognized words 410 will be streamed to the client device as speech recognition is performed. Thus, receiving recognized words 410 may be a continuous process while the meeting proceeds. The database of known keywords 422 may be queried to identify any keywords in the stream of recognized words 410. It should be understood that a keyword may include more than one word. For example, “schedule a follow-up call” may be a “keyword” as indicating that a participant wants to add a task to an action item list. Depending on various implementations, multi-word keywords may be treated as a single keyword or as multiple associated keywords. Further, a keyword may have multiple different forms. For example, a keyword may be a verb, which may be spelled differently depending on context, e.g., it is conjugated differently depending on tense, subject, etc. Thus, a keyword may include variants of a base word, e.g., “schedule,” “scheduling,” and “scheduled.” In some examples each of these may be a distinct keyword, while in other examples, the variants may be associated with a base term, e.g., “schedule,” that is used as the keyword. However, any suitable approach to recognizing keywords may be used.

If one or more keywords 415 is recognized, the sidebar assistant 400 then may identify a context 430 associated with the keyword 415. In this example, to identify a context, the sidebar assistant 400 may employ a trained machine learning (“ML”) technique to semantically analyze the speech or transcript associated with the identified keyword 415 to determine additional related keywords or if the user intends an action or not. To perform the analysis, the trained ML technique may be provided the keyword(s) and a predetermined number of words near the keyword, e.g., preceding and following the keyword(s), such as five to ten words preceding and following the keyword(s). Words such as articles (e.g., “a”, “the”) or prepositions such as “of” or “for,” may be omitted from the word count in some examples.

The ML technique may receive the sequence of words and determine whether an action was intended and, if so, what action or actions are intended. For example, if the user says “Let's schedule a follow-up call with Cady,” the ML technique may semantically analyze the words and determine that the participant would like to schedule a task and that the task involves a call with an individual named Cady. Similarly, if the user says “I'll look at scheduling a meeting with Cady,” the ML technique can semantically analyze and determine that the participant wants schedule a meeting with an individual named Cady. Alternatively, if the user says “I don't think we need to schedule that call with Cady,” the ML technique may determine that no action involving scheduling a call with an individual named Cady was intended and refrain from performing any further functions involving this phrase or the identified keyword “scheduling.”

While ML techniques may be employed in some examples, other examples of context identification 430 functionality may perform word searches for action words or phrases within a predetermined number of words from the identified keyword(s) 415. For example, considering the example above where the user says “Jerry schedule follow-up call with Cady” the context identification may perform a search for certain words surrounding the term “schedule,” “Jerry,” “call,” and “with Cady.” If one of those words is found preceding or following the term “schedule” by a predetermined number of words, the context identification 430 functionality may determine the task that is requested to be schedule.

Since people may use jargon or colloquial terms to refer to particular actions, the context identification 430 functionality may normalize recognized words to specific actions. For example, the terms “look-up,” “search,” “find,” “pull up,” etc. all refer to the action of locating information. Thus, the context identification 430 functionality may map such terms to a single action. Such mappings may be provided for multiple different actions and corresponding terms.

Once the context identification 430 has identified the one or more keywords 415, the sidebar assistant 400 may also identify one or more rules 442 to be applied based on the one or more identified keywords 415 or the participant. For example, the one or more keywords 415 may determine which function of the sidebar assistant 400 is to be invoked. As noted above, the sidebar assistant 400 may provide a notetaking functionality to the client device. The notetaking functionality may include various sub-functions, such as a task function, a note function, and a recording function.

The task function may identify tasks to add to an action item list. The task function of the sidebar assistant 400 may be invoked when certain keyword(s) are identified. For example, keywords indicating a task, such as “schedule,” “meeting,” “to-do,” etc., may invoke the task function of the sidebar assistant 400. The note function may identify that the Participant A wants notes to be taken based on the audio data. For example, keywords such as “make note,” or “write down,” may invoke the note function of the sidebar assistant 400. When invoked, the note function of the sidebar assistant 400 may record and transcribe the audio stream from the sidebar participant invoking the functionality.

The recording function may identify that a participant wants to record the audio and/or video stream from the main meeting. For example, the recording function of the sidebar assistant 400 may be invoked by keywords such as “record this” or “record the meeting.” When invoked, the recording function of the sidebar assistant 400 may record the audio and/or video streams of the main meeting (if such functions are permitted).

Depending on the function invoked by the sidebar assistant 400, different rules 442 may be identified. Rule identification 440 may identify one or more rules based on the identified keywords 415. For example, if the identified keywords 415 include “record” or other keywords invoking the recording function, the sidebar assistant 400 may identify one or more rules associated with the participant, access information for the sidebar assistant 400 into the client device, or permissions for the sidebar assistant 400 to record the main meeting, etc. For example, the sidebar assistant 400 may obtain a rule associated with the client device and the permissions for the client device to record the multimedia streams from the main meeting 365. The rule may indicate that the client device does not have permissions to record the main meeting 365. In other embodiments, the rule may indicate that the client device has permissions to record the multimedia streams. Based on the permissions level, the sidebar assistant 400 may request to record the multimedia streams from the main meeting 365 that the client device is receiving from the video conference provider 310.

It should be appreciated that while rule identification 440 functionality and context identification 430 functionality are described above as operating sequentially, they may instead operate in parallel or context identification 430 functionality may execute after the rule identification 440 functionality. As discussed above, context identification 430 may be performed using a trained ML technique to identify potential keywords, including actions associated with a keyword, e.g., by extracting some of the recognized words 410 preceding or following the keyword and providing them to the trained ML technique. Such context identification may not rely on any identified rules and thus may execute asynchronously with respect to the rule identification functionality 440. Thus, these two functionalities may operate in any sequence to determine one or more keywords.

Further, in some examples, the output of one functionality 430, 440 may be used as input to the other functionality 430, 440. For example, an identified rule may be used to identify context information. For example, if the identified rule identifies a particular descriptor word necessary to perform a search, context identification 430 may analyze the context of an identified keyword for the required descriptor. In another example, one or more identified rules may be supplied to the context identification 430 functionality to confine the potential acceptable contexts. Thus, the rule identification 440 functionality and the context identification 443 functionality may operate together to determine the function to be performed by the sidebar assistant 400.

After determining one or more functions, the sidebar assistant 400 may output a notification 450 to the participant indicating actions that may be taken based on the one or more functions identified by the recognized words 410, e.g., recording the main meeting. The notification may be displayed on the client device along with an option to take the action or to ignore the notification. Alternatively, the notification may not include any options, but may respond to being interacted with, e.g., by touching the notification (on a device with a touch screen) or moving a cursor onto the notification and pressing a button. In such embodiments, the interaction with the notification may serve as an indication for the sidebar assistant 400 to take action. Alternatively, the participant may simply ignore the notification, which may then disappear after a pre-determined period of time, e.g., five to ten seconds.

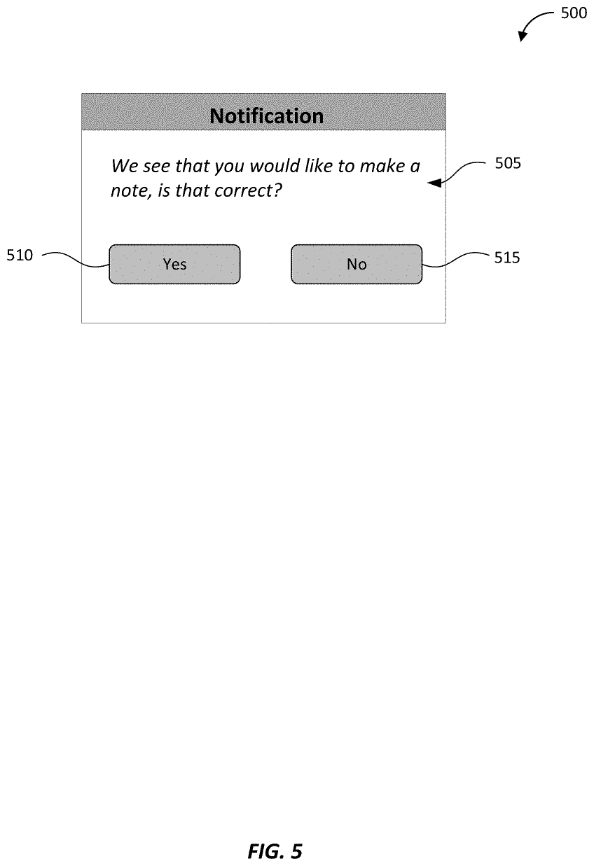

Turning now to FIG. 5, an example notification 500 confirming the function identified by sidebar assistant is provided. For the example depicted in FIG. 5, the sidebar assistant 400 may have identified the keywords “take note”. Based on the keywords “take note” and the identified context and/or rules, the sidebar assistant 400 may identify the note function. To confirm that the participant wants to take notes based on his or her speech, the sidebar assistant 400 may prompt the participant with the notification 500. The notification 500 may include an indication 505 of the one or more functions that the sidebar assistant 400 has identified. The indication 505 may be in the form of a statement that the sidebar assistant 400 has identified that the user is looking to invoke.

As discussed above, the user may interact with the notification 500 to indicate whether the sidebar assistant 400, e.g., via software on the client device, should execute the identified function or not. In this example, two options are presented on the notification 500: a “yes” button 510 and a “no” button 515. The user may then select one of these options, such as by touching it at a corresponding location on a touch screen, selecting it with a mouse cursor, etc., to either confirm that the identified function should be taken or to decline the identified function. Alternatively, in this example, the user can ignore the notification 500 and, if no action is taken within a predetermined period of time (e.g., 5-10 seconds), the notification 500 is removed from the GUI and the identified function is not performed. It should be appreciated that in some embodiments, the sidebar assistant 400 may proceed unless it receives an indication from the participant to not perform the identified function. In further embodiments, the sidebar assistant 400 may not prompt the user with the notification 500 and instead perform the identified function based on the identified keywords 415.

Returning now to FIG. 4, after the sidebar assistant 400 receives the user input 460, the sidebar assistant 400 may perform a function execution 470. For example, if the participant confirms that the sidebar assistant 400 should invoke the recording function in the user input 460, then the sidebar assistant 400 may invoke the recording function of the client device. In such an example, the sidebar assistant 400 may invoke the recording function of the video conferencing software running on the client device.

In another example, if the user input 460 confirms that the sidebar assistant 400 should take notes of the participant's speech, the sidebar assistant 400 may invoke a note function. In such an example, when the note function is invoked, the sidebar assistant 400 may request transcription of the participant's speech. In other embodiments, the sidebar assistant 400 may use the recognized words 410 received from the speech recognition source to produce a transcription of the participant's speech. The transcription may be displayed to the participant on his or her client device. The sidebar assistant 400 may transcribe a predetermined duration of the participant's speech (e.g., 15-30 seconds of audio data) or may transcribe until the participant indicates that the note is over. For example, the participant may invoke the note function of the sidebar assistant 400 by using the keywords “take note.” At that time, the sidebar assistant 400 may begin transcribing the participant's speech and displaying the transcription on the client device. Similar to invocation, the participant may terminate the note function by using the keywords “end note,” “done, “stop note,” etc. After identifying keywords indicating termination of the note function, the sidebar assistant 400 may stop transcribing and display the transcription to the participant. The transcription may be displayed to the participant as a note based on his or her spoken words.

In another example, if the user input 460 confirms that the sidebar assistant 400 should add a task to the action item list, the sidebar assistant 400 may generate a task note and add it to an action item list displayed on the participant's client device. The task note may be generated based on the keywords and the context identified by the sidebar assistant.

After the sidebar assistant 400 performs the one or more identified functions, the resulting “note” may be displayed 480 on the client device. For the note function, the generated note based on the participant's speech may be displayed on the client device. For the recording function, the snippet that was recorded from the main meeting may be provided on the client device. For the task function, the generated task note may be displayed on the client device.

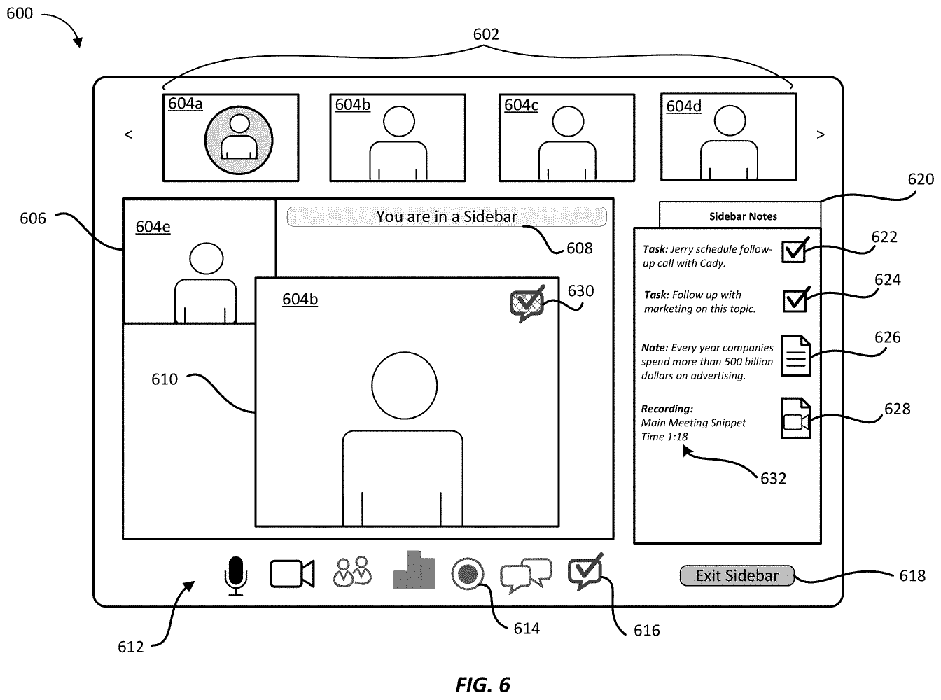

Referring now to FIG. 6, FIG. 6 illustrates a GUI 600 for a sidebar meeting in which a sidebar assistant, such as the sidebar assistant 400, is provided, according to an embodiment. The GUI 600 may be presented to a participant engaged in a sidebar meeting (e.g., the sidebar meeting 350) during a main meeting (e.g., the main meeting 365). The following figures and related components, such as GUI 600 of FIG. 6, will be described with respect to systems shown in FIGS. 3A-B, 4, and 5, however, any suitable system according to this disclosure may be employed, such as those described in FIGS. 1 and 2.

In some embodiments, a GUI 600 is viewable to a participant of the video conference on the participant's device, for example the GUI 600 may be viewable to Participant A on the client device 340a. Presentation of the GUI 600 on the participant's device may be in response to the initiation of a sidebar meeting during a video conference.

The GUI 600 may include a roster 602 of some or all of the participants 604a-e of the video conference. The roster 602 may include a video stream of the participants 604a-e. In other examples, the roster 602 may include a picture, image, representation, avatar or a listing of the participants 604a-e who have joined the main meeting. When a participant joins the video conference, the joining participant is added to the roster 602.

Once the main meeting is initiated, video and audio streams may be exchanged between the participants 604a-e. Display 606 may display the video stream of a currently speaking participant 604e in the main meeting. The audio stream from participant 604e may also be transmitted along with the display 606. In some embodiments, more than one participant may be speaking, and in such cases, display 606 may include two or more windows providing the video streams from the speaking participants.

At some time after the main meeting is initiated, one or more of the participants 604a-d may engage in a sidebar meeting with another participant. For example, participant 604a may engage with participant 604b in a sidebar meeting. Once the sidebar meeting is established, the main meeting display 606 may reduce in size and be repositioned away from the central focus of the GUI 600, as illustrated by FIG. 6. And at the same time, a display 610 of the participant 604b's video stream may be enlarged and positioned in the central focus of the GUI 600. The sizing, arrangement, and configuration of the main meeting display 606 and the display 610 of the other sidebar participant(s) video stream may vary. In embodiments where there is more than one sidebar participant, the display 610 may include the additional sidebar participant's video stream, similar to how video streams are displayed in conventional video conferences. In this manner, the participant 604a can know what participants are engaged in the sidebar meeting.

As noted above, in some embodiments, the sidebar meeting may be an audio-only sidebar meeting. In some such cases, the GUI 600 may not include the display 610. Instead, the display 606 may remain the central focus of the GUI 600 and the participant 604a may only receive the audio stream from the participant 604b, not the video stream. In some cases, the GUI 600 may indicate to the participant in the audio-only sidebar meeting that the participant is in an audio-only sidebar meeting. For example, the display 610 may provide a silhouette representation of the other participant(s) in the audio-only sidebar meeting or provide an “audio-only” notice.

While in the sidebar meeting, participants 604a and 604b can receive two audio streams: one from the main meeting 365 and one from the sidebar meeting 350. Upon entry into the sidebar meeting 350, the client devices of the sidebar participants (e.g., participants 604a and 604b) may be configured to target and provide audio from the sidebar meeting 350 over the audio from the main meeting 365, since the sounds from the two virtual meeting rooms would likely overlap, be difficult to understand, and may lack saliency if they were output to the client device at the same time.

To prevent the sidebar participants 604a and 604b from receiving the two audio streams at full volume at the same time, the sidebar participants 604a and 604b can adjust the volume of audio streams from the main meeting 365 to a background level while the audio streams from the sidebar meetings 350 remain at a normal audio level. In some cases, the audio level of each respective audio stream may be automatically adjusted upon entry into the sidebar meeting 350. For example, upon joining the sidebar meeting 350, the audio from the main meeting 365 may be muted and the audio from the sidebar meeting 350 may be provided at a normal level. The sidebar participants 604a and 604b may have the option to receive audio streams from both the main meeting 365 and the sidebar meeting 350, such as by reducing the volume of one of the two audio streams, or by playing each audio stream from a different audio output device, e.g., the main meeting audio is played from the left speaker and the sidebar meeting audio is played from the right speaker.

With the participants 604a and 604b engaging in the sidebar meeting, the GUI 600 may provide an indication 608 that the participants 604a and 604b are in a sidebar meeting, and not in the main meeting. For example, as illustrated, the indication 608 may notify or otherwise indicate that the participants 604a and 604b are in a sidebar meeting. In some embodiments, instead of a banner, like the indication 608, the background of the GUI 600 may change colors, or the display 606 of the main meeting may highlight or pulse to indicate that the participants 604a and 604b are not in the main meeting.

The GUI 600 may also include a dashboard 612 containing one or more action selections. For example, dashboard 612 may include a recording selection 614 that allows a participant to record the streams of audio and video during the video conference. The dashboard 612 may also include a sidebar assistant selector 616. The sidebar assistant selector 616 may allow a participant to enable the sidebar assistant or to disable the sidebar assistant during the virtual meeting. For example, in some embodiments, a participant may want to disable the sidebar assistant during a virtual meeting. In such cases, even when the participant engages in a sidebar meeting, the sidebar assistant may be disabled and not monitor the participant's audio stream.

When the sidebar assistant is enabled during a virtual meeting, the sidebar assistant may remain dormant until the participant engages in a sidebar meeting. For example, the sidebar assistant functionality may not be invoked to monitor the audio streams being received and/or transmitted from the participant's client device until the participant engages in a sidebar meeting. The sidebar assistant may determine that the participant engages in a sidebar meeting by identifying a second audio channel being received by the participant's client device. For example, the sidebar assistant may determine a first audio stream and a first video stream corresponding to the main meeting being received by the client device. When the participant engages in the sidebar meeting, the participant's client device may receive a second audio stream, and optionally, a second video stream. The sidebar assistant may identify the second audio stream from the sidebar meeting and begin monitoring the audio data. In another embodiment, the sidebar assistant may determine that the participant is engaged in a sidebar meeting by receiving an indication from the video conference provider or the video conferencing software on the client device.

When the sidebar assistant is invoked and the participant is in a sidebar meeting, sidebar assistant indication 630 may be provided on GUI 600 to indicate to the participant that the sidebar assistant is monitoring the audio streams. For example, as illustrated, the indication 630 may be provided as part of display 610 to indicate to the participant 604a that the audio streams to and from his or her client device are being monitored for the keywords. If the participant 604a does not want the sidebar audio streams to be monitored at any time during the sidebar meeting, the participant 604a can disable the sidebar assistant.

Once the sidebar assistant determines that the participant is engaging in a sidebar meeting, the sidebar assistant functionality may be invoked. When invoked, the sidebar assistant functionality may monitor the sidebar meeting audio data. The sidebar meeting audio data may include the audio streams received and transmitted by the participant's client device.

The sidebar assistant may monitor the audio streams of the participants in the sidebar meeting. In some embodiments, the sidebar assistant functionality may be specific to an individual participant in the sidebar meeting (e.g., only monitoring the audio streams of that participant), or the sidebar assistant functionality may monitor the audio streams of all participants in the sidebar meeting. In some cases, the streams that the sidebar assistant monitors may depend on the computing device executing the sidebar assistant. For example, if the sidebar assistant is locally-based on a participant's client device, then only the audio streams received and transmitted by that participant's client device may be monitored. If the sidebar assistant is remotely-based, such as on a computing device of the video conference provider, then the sidebar assistant may monitor all the audio streams exchanged in a sidebar meeting. The audio streams that are monitored may also depend on privacy settings and permissions of each participant's client device. In the embodiments where the sidebar assistant is monitoring all the audio streams in the sidebar meeting (e.g., not just the audio stream specific to a single participant), the sidebar participants may be notified upon initiation of the sidebar meeting or during the sidebar meeting when the sidebar assistant is enabled. To ensure privacy of the sidebar participants, each sidebar participant may be provided an indication that the sidebar assistant is monitoring the sidebar audio streams.

Once invoked, the sidebar assistant functionality may begin performing speech recognition on the sidebar audio streams, as discussed above with reference to FIGS. 3 and 4. For example, to perform the sidebar assistant functionality, the video conference provider 310 may identify the audio streams for the sidebar meeting 350 and indicate that speech recognition should be performed on the incoming audio data from each of the client devices 340a-c participating in the sidebar meeting 350. For example, the video conference provider 310 may identify a client device that is transmitting audio and video streams during the sidebar meeting 350 and perform speech recognition on the corresponding audio data. In the cases where the speech recognition is performed by a different remote computing device, the video conference provider 310 may provide the identified audio data from the main meeting to the remote computing device for speech recognition purposes.

In some embodiments, the sidebar assistant functionality may include a speech recognition functionality and a notetaking functionality, as described above. For example, once the sidebar assistant functionality is enabled, the speech recognition function may be initiated. In response to enablement of the sidebar assistant functionality, the video conference provider 310 may begin executing speech recognition on incoming audio data from the participants in the sidebar meeting 350 and the sidebar assistant may perform the notetaking functionality as described above with respect to FIG. 4.

It should be appreciated that the sidebar assistant functionality may be enabled or disabled at any time during a meeting. Enabling or disabling the functionality will cause the client device 340a to transmit an indication to the video conference provider 310 to activate or deactivate speech recognition for sidebar audio data exchanged with the client device 340a. Further, while this example is discussed with respect to client device 340a, any of the client device 330 and 340b-340m may take advantage of such functionality by enabling respective sidebar assistant functionality as discussed herein.

In some embodiments, the sidebar assistant functionality may be integrated into the video conferencing software. In other embodiments, the sidebar assistant may be a standalone application from the video conferencing application. For example, upon initiation of the video conferencing application, the sidebar assistant application may automatically launch. In cases where the sidebar assistant functionality is disabled upon launch of a video conference, the sidebar assistant application may launch when the sidebar assistant functionality is enabled by the user of the client device.

Once speech recognition is performed on the sidebar meeting audio data exchanged with the client device 340a, the recognized words from the speech recognition may be provided to the sidebar assistant to perform the notetaking functionality, as described above with respect to FIG. 4. Depending on where speech recognition is performed, the processing capabilities of the computing device performing speech recognition, and network conditions (if speech recognition is performed remotely from the client device), recognized words may be provided to the sidebar assistant within a few seconds of the participant speaking them. For example, in some embodiments, the sidebar assistant may not include a speech recognition function. Instead, the sidebar assistant may receive the recognized words, for example via a transcript of the audio, from a remote computing device.

Once the sidebar assistant has performed the notetaking function, and generated a note in accordance with the various sub-functions (e.g., task function, note function, recording function), the sidebar assistant may display the notes on the GUI 600. As illustrated, the notes generated by the sidebar assistant may be displayed in a sidebar notes 620. The sidebar notes 620 may be a dialog box in which the notes generated by the sidebar assistant are displayed. The sidebar notes 620 may display notes generated by all sidebar assistants during a given sidebar meeting. As noted above, in some embodiments, the sidebar assistant may be specific to an individual participant. In such cases, there may be more than one sidebar assistant invoked during a given sidebar meeting. For example, each participant in a sidebar meeting may have a sidebar assistant monitoring the audio data exchanged from his or her client device during a sidebar meeting. If that is the case, then the sidebar notes 620 may include the notes generated by each of the sidebar assistants.

As discussed above, the sidebar assistant may generate different types of notes depending on the sub-function invoked. Example notes include task notes 622 and 624, a note 626, and a recording note 628. The task notes 622 and 624 may be notes generated by the sidebar assistant when a task function is identified and invoked. For example, the task function may be identified by participant 604a stating “Jerry, you should schedule a follow-up call with Cady.” Based on the keywords, context, and/or rules, the sidebar assistant may perform the task function and generate the task note 622. The task note 622 may indicate the identified task that the participant 604a desired to add to an action item list. Similarly, task note 624 may identify another task that a participant in the sidebar meeting desires to add to the action item list.

The note 626 may be a note generated by the sidebar assistant when a note function is identified and invoked. For example, the note function may be identified by the sidebar assistant when a participant in the sidebar meeting says “Let's make a note that every year companies spend more than 500 billion dollars on advertising.” Based on the keywords, context, and/or rules, the sidebar assistant may perform the note function and generate the note 626 that reads “every year companies spend more than 500 billion dollars on advertising.” As described above, the note 626 may be a transcription of the speaking participant's audio data.

The recording note 628 may be generated by the sidebar assistant when a recording function is identified and invoked. For example, the recording function may be identified by the sidebar assistant when a participant in the sidebar meeting says “Let's record this part of the meeting.” Based on the keywords, context, and/or rules, the sidebar assistant may perform the recording function and generate the note 628. The recording note 628 may be a short recording or snippet of the main meeting at the time that the participant invoked the recording function of the sidebar assistant.

In some embodiments, the audio and video data from the main meeting corresponding to the generated note may be captured by the sidebar assistant to provide context to the sidebar participant on the note. For example, for the note 626, the sidebar assistant may have recorded the multimedia streams from the main meeting for a short, predetermined time duration following invocation of the sidebar assistant note function by the participant. In some embodiments, the sidebar assistant may record at least 5 seconds, at least 10 seconds, at least 20 seconds, or at least 30 seconds of the multimedia streams from the main meeting after the note function and/or the task function is invoked. Since the recording function already records one or more multimedia streams from the main meeting, the sidebar assistant does not need to perform an additional recording of the main meeting streams.

In some embodiments, instead of or in addition to recording the audio and video streams from the main meeting for a given note, the sidebar assistant may provide a timestamp corresponding to the note. If the main meeting is recorded, this may allow the participant to revisit the main meeting recording for context on a given note. For example, as illustrated, the recording note 628 may have a timestamp 632. The timestamp 632 may indicate the time into the main meeting at which the recording function was invoked (e.g., the time at which the recording note 628 begins). If the main meeting is recorded and the sidebar participant needs more context for the recording note 628 (e.g., the recording note 628 misses an introduction topic), the sidebar participant can revisit the main meeting recording and using the timestamp know where to begin watching for context on the recording note 628.

In some embodiments, a sidebar participant may be able to edit the notes 622-628 as they are generated in the sidebar notes 620. For example, if the sidebar participant sees that the sidebar assistant incorrectly transcribed the note 626 to say “400 billion dollars,” the sidebar participant can select the note and edit the note to read “500 billion dollars.” For example, the sidebar participant can use a cursor or otherwise select the portion of the note the participant wishes to edit. In some embodiments, the participant may desire to add more information to the generated note. For example, the sidebar participant may want to add a phone number to the task note 622. To do so, the sidebar participant can select and edit the task note 622 to add the phone number.

The notes 622-628 may be added to the sidebar notes 620 as the sidebar assistant generates them. In this manner, the sidebar notes 620 provides a nearly continuous and/or real-time listing of the notes 622-628 as they are requested by the participant. Additionally, the sidebar participant can edit them as they are being produced on the sidebar notes 620. This can allow for the sidebar assistant to produce accurate notes in real-time during the main meeting.

When the sidebar conversation is completed, and one or more of the sidebar participants wants to rejoin the main meeting, the sidebar participant may exit the sidebar meeting. For example, as illustrated, the GUI 600 may include an exit sidebar button 618. If participant 604a wishes to return to the main meeting and exit the sidebar meeting, the participant 604a may select the exit sidebar button 618 and the participant 604a may be returned to the main meeting. Upon exiting the sidebar meeting, the display 610 of the video stream from the other sidebar participants may disappear and the display 606 of the main meeting may enlarge and return to the main focus of the GUI 600. Additionally, the audio stream from the sidebar meeting may be terminated and the client device of the participant 604a may only receive the audio and video stream from the main meeting.

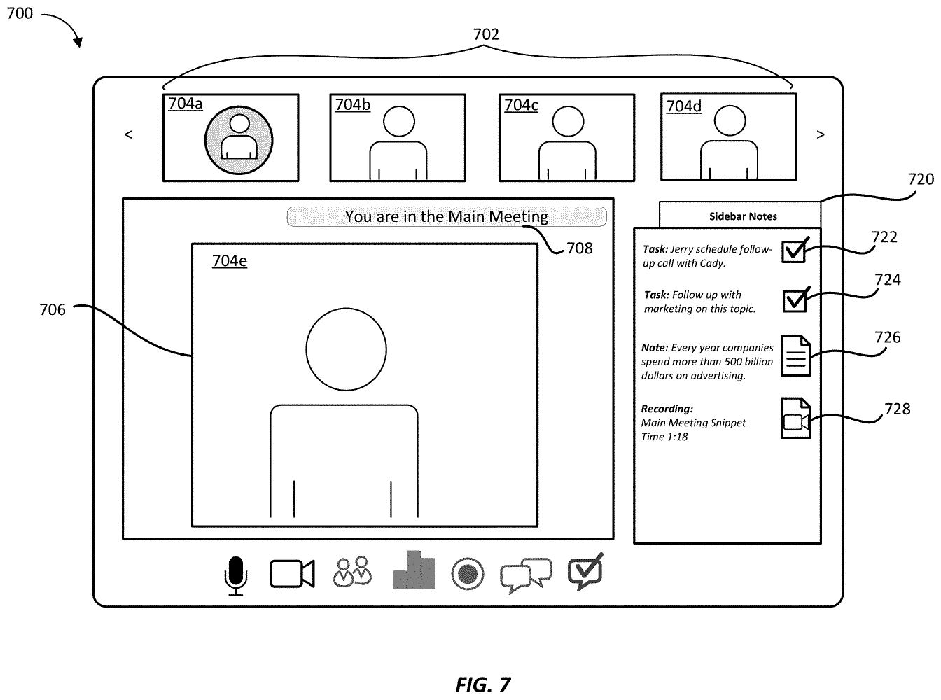

After the sidebar meeting terminates, and the sidebar participants return to the main meeting, the sidebar notes may remain on the participant's GUI. Referring now to FIG. 700, a GUI 700 for a main meeting is provided, according to an embodiment herein. The GUI 700 may be presented to a participant during a main meeting, such as the main meeting 365. The following figures and related components, such as GUI 700 of FIG. 7, will be described with respect to systems shown in FIG. 6, however, any suitable system according to this disclosure may be employed, such as those described in FIGS. 1-5.

In some embodiments, a GUI 700 is viewable to a participant of the video conference on the participant's device, for example the GUI 700 may be viewable to participant 604a upon exiting a sidebar meeting. As shown, the GUI 700 may include a roster 702 of some or all of participants 704a-d of the video conference. The roster 702 may be the same as the roster 602, and the participants 704a-d may be the same as the participants 604a-d.

Once the main meeting is initiated, video and audio streams may be exchanged between the participants 704a-d. Display 706 may display the video stream of a currently speaking participant 704e. The audio stream from participant 704e may also be transmitted along with the display 706. In some embodiments, more than one participant may be speaking, and in such cases, display 706 may include two or more windows providing the video streams from the speaking participants. As noted above, when a participant exits a sidebar meeting, thereby returning to the main meeting, the display 610 of the sidebar meeting may disappear and the display 606 of the main meeting may be rearranged to a central focus of the GUI 600. In some embodiments, the display 606 may rearrange to the display 706, as illustrated by FIG. 7.

To indicate to the participants 704a-d that they are in the main meeting, indication 708 may be provided. The indication 708 may be helpful for participants 704a-d to know that their audio and video streams are being transmitted to participants of the main meeting. If a participant is engaging in sidebar conversations throughout the main meeting, the participant could easily become confused as to which virtual meeting space he or she is in and accidently say or share something in the main meeting meant for the sidebar conversation. The indication 708 can help orient a participant within the virtual space.

As noted above, when a participant returns from a sidebar meeting, the sidebar notes may continue to be displayed to the participant. For example, sidebar notes 720 may correspond to the sidebar notes 620. The sidebar notes 720 may include notes 722-728 which correspond to the notes 622-628. When the sidebar meeting depicted in FIG. 6 is terminated, the sidebar notes 620 from the sidebar meeting may remain as sidebar notes 720 on the GUI 700. This can allow a participant to see the notes generated during the sidebar meeting. The notes 722-728 may also remain editable when the participant is in the main meeting so that the participant can edit as needed during the meeting.

After the main meeting terminates, and all the participants are disconnected from the video conference, the sidebar notes 720 may be shared or sent to the participants. For example, after the video conference ends, the sidebar notes 720 may be emailed to the participants that engaged in the sidebar meeting. This can allow the participants to have access to the notes 722-728 that were generated during the sidebar meeting. Following the video conference, the sidebar notes 720 can provide the participants a written listing of the notes 722-728 that were generated during the sidebar meeting.

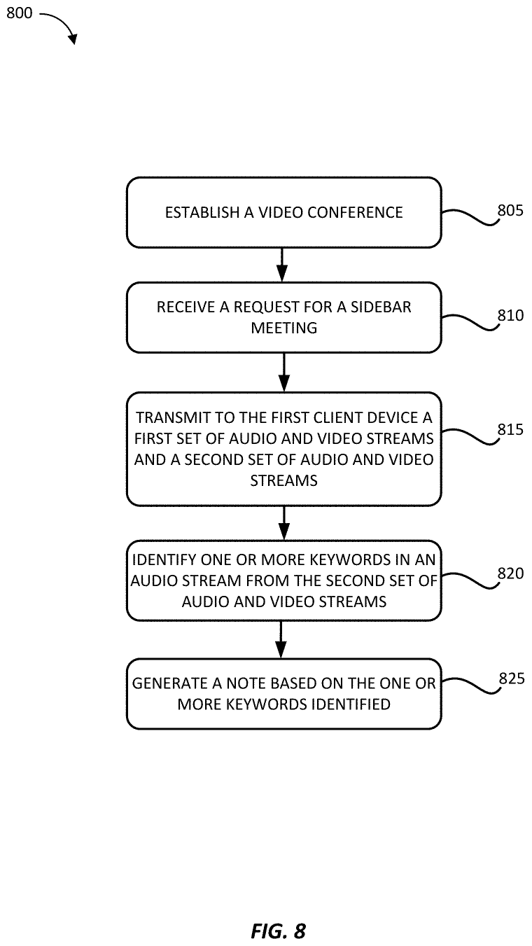

Referring now to FIG. 8, a flowchart of an example method 800 for providing sidebar assistant functionality for a sidebar meeting during a video conference is provided. The description of the method 800 in FIG. 8 may be made with reference to FIGS. 3A-7, however any suitable system according to this disclosure may be used, such as the example systems 100 and 200, shown in FIGS. 1 and 2.

The method 800 may include a step 805. At step 805, a video conference may be established. For example, the video conference may be established by the video conference provider 310. The video conference may include one or more participants. At step 810, a request for a sidebar meeting may be received from a first client device. For example, the video conference provider 310 may receive a request for a sidebar meeting from the participant client device 340a, as described above with reference to FIG. 3B. After receiving the request for the sidebar meeting, the method 800 may include transmitting to the first client device a first set of audio and video streams and a second set of audio and video streams, at step 815. The first set of audio and video streams may correspond to a main meeting of the video conference and the second set of audio and video streams may correspond to the sidebar meeting.

Method 800 may include step 820. At step 820, one or more keywords in an audio stream from the second set of audio and video streams corresponding to the sidebar meeting may be identified. The one or more keywords may be identified by a sidebar assistant, such as the sidebar assistant 400. In some examples, the sidebar assistant may transcribe the audio stream from the second set of audio and video streams to generate a transcription of the audio stream. Then, the sidebar assistant may analyze the transcription of the audio stream for the one or more keywords. In another example, the method 800 may also include performing speech recognition on the audio stream from the second set of audio and video streams to identify one or more recognized words. Then, based on the one or more recognized words, the one or more keywords may be identified.

Method 800 may also include step 825. At step 825, the sidebar assistant may generate a note based on the one or more keywords identified in the audio stream. In some cases, the method 800 may include, responsive to generating, by the sidebar assistant, the note based on the one or more keywords, and recording, by the sidebar assistant, a segment of the first set of audio and video streams corresponding to the main meeting. The segment of the first set of audio and video streams recorded may correspond to a time that the one or more keywords were identified by the sidebar assistant.

Prior to step 825, the method 800 may include determining, by the sidebar assistant, one or more functions to invoke based on the one or more keywords. For example, the one or more functions may include a recording function, a note function, or a task function. In an example where the function includes a recording function, the method may include recording, by the sidebar assistant, a segment of the first set of audio and video streams from the main meeting responsive to invoking the recording function based on the one or more keywords.

In an example where the function includes a note function, the method may include transcribing, by the sidebar assistant, a segment of the audio stream from the second set of audio and video streams responsive to determining to invoke the function based on the one or more keywords. The sidebar assistant may then generate a note based on the segment of audio stream from the second set of audio and video streams that were transcribed.

In an example where the function includes a task function, the method 800 may include generating, by the sidebar assistant, a task note, responsive to the determining to invoke the task function based on the one or more keywords.

In some examples, the method 800 may include receiving, from the first client device, a request to exit the sidebar meeting. For example, the video conference provider 310 may receive the request to exit the sidebar meeting from the first client device. Responsive to the request, the method may include terminating transmission to the first client device of the second set of audio and video streams corresponding to the sidebar meeting. In some cases, the method 800 may include displaying, on the first client device, the note as part of the sidebar note. In further examples, the method 800 may include transmitting, to the first client device, a notification that the main meeting is terminated and terminating transmission, to the first client device, the first set of audio and video streams corresponding to the main meeting. Upon termination of the main meeting, the method 800 may include transmitting, to the first client device, the sidebar note including the note generated by the sidebar assistant.

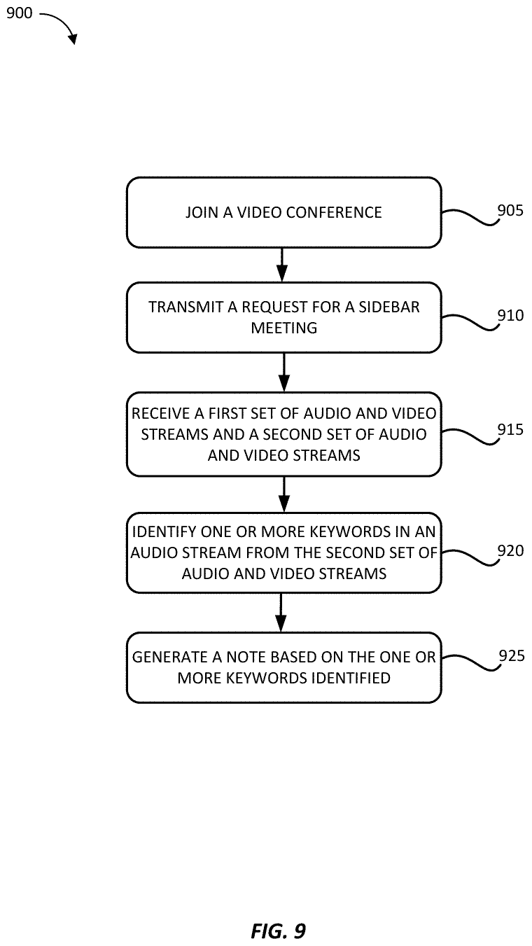

Referring now to FIG. 9, a flowchart of another example method 900 for providing sidebar assistant functionality for a sidebar meeting during a video conference is provided. The description of the method 900 in FIG. 9 may be made with reference to FIGS. 3A-8, however any suitable system according to this disclosure may be used, such as the example systems 100 and 200, shown in FIGS. 1 and 2. In one aspect, the method 900 may be similar to the method 800 except from a viewpoint of a client device.

The method 900 may include a step 905 at which a video conference may be joined. For example, a first client device, such as participant client device 340a, may join a video conference, such as the main meeting 365. The video conference may include one or more participants, such as participants A-M, as described above with reference to FIG. 3B.

During the video conference, the first client device may transmit a request for a sidebar meeting, at step 910. For example, the participant client device 340a may transmit a request for a sidebar meeting to the video conference provider 310, as described above with reference to FIG. 3B. After transmitting the request for the sidebar meeting, the method 900 may include receiving by the first client device a first set of audio and video streams and a second set of audio and video streams, at step 915. The first set of audio and video streams may correspond to a main meeting of the video conference and the second set of audio and video streams may correspond to the sidebar meeting. The video conference provider 310 may transmit the first and second set of audio and video streams to the first client device.

Method 900 may include step 920. At step 920, one or more keywords in an audio stream from the second set of audio and video streams corresponding to the sidebar meeting may be identified. The one or more keywords may be identified by a sidebar assistant, such as the sidebar assistant 400. The sidebar assistant 400 may be running locally on the client device or be running on a remote client device, such as a third party server. The sidebar assistant of method 900 may function the same as or similar to the sidebar assistant described above with respect to method 800. For example, the sidebar assistant may transcribe the audio stream from the second set of audio and video streams to generate a transcription of the audio stream. Then, the sidebar assistant may analyze the transcription of the audio stream for the one or more keywords. In another example, the method 900 may also include performing speech recognition on the audio stream from the second set of audio and video streams to identify one or more recognized words. Then, based on the one or more recognized words, the one or more keywords may be identified.

The sidebar assistant may generate a note based on the one or more keywords identified in the audio stream, at step 925. In some cases, the method 900 may include, responsive to generating, by the sidebar assistant, the note based on the one or more keywords, recording, by the sidebar assistant, a segment of the first set of audio and video streams corresponding to the main meeting. The segment of the first set of audio and video streams recorded may correspond to a time that the one or more keywords were identified by the sidebar assistant.

Prior to step 925, the method 900 may include determining, by the sidebar assistant, one or more functions to invoke based on the one or more keywords. For example, the one or more functions may include a recording function, a note function, or a task function. In an example where the function includes a recording function, the method may include recording, by the sidebar assistant, a segment of the first set of audio and video streams from the main meeting responsive to invoking the recording function based on the one or more keywords.

Similar to method 800, in an example where the function includes a note function, the method may include transcribing, by the sidebar assistant, a segment of the audio stream from the second set of audio and video streams responsive to determining to invoke the function based on the one or more keywords. The sidebar assistant may then generate a note based on the segment of audio stream from the second set of audio and video streams transcribe. In an example where the function includes a task function, the method 900 may include generating, by the sidebar assistant, a task note, responsive to the determining to invoke the task function based on the one or more keywords.

In some examples, the method 900 may include transmitting, from the first client device, a request to exit the sidebar meeting. For example, the first client device may transmit to the video conference provider 310 the request to exit the sidebar meeting from the first client device. Responsive to the request, the method may include terminating receipt, by the first client device, of the second set of audio and video streams corresponding to the sidebar meeting. In some cases, the method 900 may include displaying, on the first client device, the note as part of the sidebar note. In further examples, the method 900 may include receiving, by the first client device, a notification that the main meeting is terminated and terminating receipt, by the first client device, the first set of audio and video streams corresponding to the main meeting. Upon termination of the main meeting, the method 900 may include transmitting, to the first client device, the sidebar note including the note generated by the sidebar assistant.

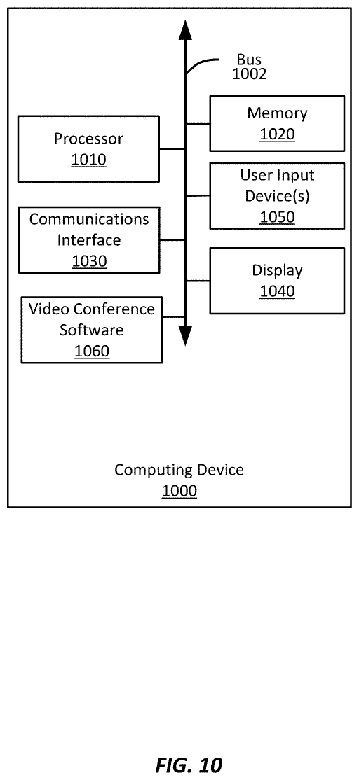

Referring now to FIG. 10, FIG. 10 shows an example computing device 1000 suitable for use in example systems or methods for providing sidebar assistant functionality in a sidebar meeting during a video conference. The example computing device 1000 includes a processor 1010 which is in communication with the memory 1020 and other components of the computing device 1000 using one or more communications buses 1002. The processor 1010 is configured to execute processor-executable instructions stored in the memory 1020 to perform one or more methods for providing sidebar assistant functionality during a sidebar meeting, such as part or all of the example methods 800 and 900, described above with respect to FIGS. 8 and 9, respectively. The computing device, in this example, also includes one or more user input devices 1050, such as a keyboard, mouse, touchscreen, video input device (e.g., one or more cameras), microphone, etc., to accept user input. The computing device 1000 also includes a display 1040 to provide visual output to a user.

The computing device 1000 also includes a communications interface 1030. In some examples, the communications interface 1030 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification

As used below, any reference to a series of examples is to be understood as a reference to each of those examples disjunctively (e.g., “Examples 1-4” is to be understood as “Examples 1, 2, 3, or 4”).

Example 1 is a system comprising: a non-transitory computer-readable medium; a communications interface; and a processor communicatively coupled to the non-transitory computer-readable medium and the communications interface, the processor configured to execute processor-executable instructions stored in the non-transitory computer-readable medium to: establish a video conference having a plurality of participants; receive, from a first client device, a request for a sidebar meeting; transmit to the first client device: a first set of audio and video streams corresponding to a main meeting; and a second set of audio and video streams corresponding to the sidebar meeting; identify, by a sidebar assistant, one or more keywords in an audio stream from the second set of audio and video streams corresponding to the sidebar meeting; and generate, by the sidebar assistant, a note based on the one or more keywords identified in the audio stream from the second set of audio and video streams corresponding to the sidebar meeting.

Example 2 is the system of any previous or subsequent Example, wherein the processor is configured to execute further processor-executable instructions stored in the non-transitory computer-readable medium to: transcribe, by the sidebar assistant, the audio stream from the second set of audio and video streams to generate a transcription; and analyze, by the sidebar assistant, the transcription for the one or more keywords.

Example 3 is the system of any previous or subsequent Example, wherein the processor is configured to execute further processor-executable instructions stored in the non-transitory computer-readable medium to: perform speech recognition on the audio stream from the second set of audio and video streams to identify one or more recognized words; and identify, based on the one or more recognized words, the one or more keywords.

Example 4 is the system of any previous or subsequent Example, wherein the processor is configured to execute further processor-executable instructions stored in the non-transitory computer-readable medium to: receive, from the first client device, a request to exit the sidebar meeting; and responsive to the request to exit the sidebar meeting, terminate transmission, to the first client device, of the second set of audio and video streams corresponding to the sidebar meeting.

Example 5 is the system of any previous or subsequent Example, wherein the processor is configured to execute further processor-executable instructions stored in the non-transitory computer-readable medium to: display, on the first client device, a sidebar note, wherein the sidebar note comprises the note generated by the sidebar assistant.

Example 6 is the system of any previous or subsequent Example, wherein the processor is configured to execute further processor-executable instructions stored in the non-transitory computer-readable medium to: determine, by the sidebar assistant, one or more functions to invoke based on the one or more keywords, wherein the one or more functions comprise at least one of: a recording function; a note function; or a task function.

Example 7 is the system of any previous or subsequent Example, wherein the one or more functions comprises a recording function, and wherein the processor is configured to execute further processor-executable instructions stored in the non-transitory computer-readable medium to: record, by the sidebar assistant, a segment of the first set of audio and video streams from the main meeting, responsive to determining, by the sidebar assistant, to invoke the recording function based on the one or more keywords.

Example 8 is a method comprising: establishing, by a video conference provider, a video conference having a plurality of participants; receiving, from a first client device, a request for a sidebar meeting; transmitting to the first client device: a first set of audio and video streams corresponding to a main meeting; and a second set of audio and video streams corresponding to the sidebar meeting; identifying, by a sidebar assistant, one or more keywords in an audio stream from the second set of audio and video streams corresponding to the sidebar meeting; and generating, by the sidebar assistant, a note based on the one or more keywords identified in the audio stream from the second set of audio and video streams corresponding to the sidebar meeting.

Example 9 is the method of any previous or subsequent Example, wherein identifying, by the sidebar assistant, the one or more keywords in the audio stream from the second set of audio and video streams comprises: performing, by a computing device, speech recognition on the audio stream from the second set of audio and video streams to identify one or more recognized words.

Example 10 is the method of any previous or subsequent Example, wherein: performing, by the computing device, speech recognition on the audio stream from the second set of audio and video streams comprises transcribing, by the computing device, the audio stream from the second set of audio and video streams to generate a transcription of the audio stream; and identifying, by the sidebar assistant, the one or more keywords in the audio stream from the second set of audio and video streams corresponding to the sidebar meeting comprises identifying, by the sidebar assistant, the one or more keywords from the transcription.

Example 11 is the method of any previous or subsequent Example, further comprising determining, by the sidebar assistant, one or more functions to invoke based on the one or more keywords.

Example 12 is the method of any previous or subsequent Example, wherein the one or more functions comprises a recording function, and the method further comprises: recording, by the sidebar assistant, a segment of the first set of audio and video streams from the main meeting, responsive to determining, by the sidebar assistant, to invoke the recording function based on the one or more keywords; and generating, by the sidebar assistant, a recording note based on the segment of the first set of audio and video streams recorded.

Example 13 is the method of any previous or subsequent Example, wherein the one or more functions comprises a note function, and the method further comprises: transcribing, by the sidebar assistant, a segment of the audio stream from the second set of audio and video streams corresponding to the sidebar meeting, responsive to determining, by the sidebar assistant, to invoke the note function based on the one or more keywords; and generating, by the sidebar assistant, the note based on the segment of the audio stream from the second set of audio and video streams transcribed.

Example 14 is the method of any previous or subsequent Example, wherein the one or more functions comprises a task function, and the method further comprises: generating, by the sidebar assistant, a task note, responsive to determining, by the sidebar assistant, to invoke the task function based on the one or more keywords.

Example 15 is a non-transitory computer-readable medium comprising processor-executable instructions configured to cause one or more processors to: establish a video conference having a plurality of participants; receive, from a first client device, a request for a sidebar meeting; transmit to the first client device: a first set of audio and video streams corresponding to a main meeting; and a second set of audio and video streams corresponding to the sidebar meeting; identify, by a sidebar assistant, one or more keywords in an audio stream from the second set of audio and video streams corresponding to the sidebar meeting; and generate, by the sidebar assistant, a note based on the one or more keywords identified in the audio stream from the second set of audio and video streams corresponding to the sidebar meeting.

Example 16 is the non-transitory computer-readable medium of any previous or subsequent Example, wherein the processor is configured to execute further processor-executable instructions stored in the non-transitory computer-readable medium to: display in response to generating the note, on the first client device, a sidebar note, wherein the sidebar note comprises notes generated by the sidebar assistant.

Example 17 is the non-transitory computer-readable medium of any previous or subsequent Example, wherein the processor is configured to execute further processor-executable instructions stored in the non-transitory computer-readable medium to: transmit, to the first client device, a notification that the main meeting is terminated; terminate transmission, to the first client device, the first set of audio and video streams corresponding to the main meeting; and transmit, to the first client device, the sidebar note, wherein the sidebar note comprises the note generated by the sidebar assistant.

Example 18 is the non-transitory computer-readable medium of any previous or subsequent Example, wherein the processor is configured to execute further processor-executable instructions stored in the non-transitory computer-readable medium to: receive, from the first client device, an indication to exit the sidebar meeting; terminate transmission, to the first client device, the second set of audio and video streams corresponding to the sidebar meeting; and display, on the first client device, the note as part of a sidebar note.

Example 19 is the non-transitory computer-readable medium of any previous or subsequent Example, wherein the processor is configured to execute further processor-executable instructions stored in the non-transitory computer-readable medium to: responsive to generating, by the sidebar assistant, the note based on the one or more keywords, record, by the sidebar assistant, a segment of the first set of audio and video streams corresponding to the main meeting, wherein the segment of the first set of audio and video streams recorded corresponds to a time that the one or more keywords were identified by the sidebar assistant.

Example 20 is the non-transitory computer-readable medium of any previous or subsequent Example, wherein the processor is configured to execute further processor-executable instructions stored in the non-transitory computer-readable medium to: provide, by the sidebar assistant, a timestamp based on the note, wherein the timestamp corresponds to a time in the main meeting when the one or more keywords were identified.

That which is claimed is:

1. A system comprising:
a non-transitory computer-readable medium;
a communications interface; and
a processor communicatively coupled to the non-transitory computer-readable medium and the communications interface, the processor configured to execute processor-executable instructions stored in the non-transitory computer-readable medium to:
establish a video conference having a plurality of participants;
receive, from a first client device, a request for a sidebar meeting;
transmit to the first client device:
a first set of audio and video streams corresponding to a main meeting; and
a second set of audio and video streams corresponding to the sidebar meeting;
identify, by a sidebar assistant, one or more keywords in an audio stream from the second set of audio and video streams corresponding to the sidebar meeting; and
generate, by the sidebar assistant, a note based on the one or more keywords identified in the audio stream from the second set of audio and video streams corresponding to the sidebar meeting.

2. The system of claim 1, wherein the processor is configured to execute further processor-executable instructions stored in the non-transitory computer-readable medium to:
transcribe, by the sidebar assistant, the audio stream from the second set of audio and video streams to generate a transcription; and
analyze, by the sidebar assistant, the transcription for the one or more keywords.

3. The system of claim 1, wherein the processor is configured to execute further processor-executable instructions stored in the non-transitory computer-readable medium to:
perform speech recognition on the audio stream from the second set of audio and video streams to identify one or more recognized words; and
identify, based on the one or more recognized words, the one or more keywords.

4. The system of claim 1, wherein the processor is configured to execute further processor-executable instructions stored in the non-transitory computer-readable medium to:
receive, from the first client device, a request to exit the sidebar meeting; and
responsive to the request to exit the sidebar meeting, terminate transmission, to the first client device, of the second set of audio and video streams corresponding to the sidebar meeting.

5. The system of claim 4, wherein the processor is configured to execute further processor-executable instructions stored in the non-transitory computer-readable medium to:
display, on the first client device, a sidebar note, wherein the sidebar note comprises the note generated by the sidebar assistant.

6. The system of claim 1, wherein the processor is configured to execute further processor-executable instructions stored in the non-transitory computer-readable medium to:
determine, by the sidebar assistant, one or more functions to invoke based on the one or more keywords, wherein the one or more functions comprise at least one of:
a recording function;
a note function; or
a task function.

7. The system of claim 6, wherein the one or more functions comprises a recording function, and wherein the processor is configured to execute further processor-executable instructions stored in the non-transitory computer-readable medium to:
record, by the sidebar assistant, a segment of the first set of audio and video streams from the main meeting, responsive to determining, by the sidebar assistant, to invoke the recording function based on the one or more keywords.

8. A method comprising:
establishing, by a video conference provider, a video conference having a plurality of participants;
receiving, from a first client device, a request for a sidebar meeting;
transmitting to the first client device:
a first set of audio and video streams corresponding to a main meeting; and
a second set of audio and video streams corresponding to the sidebar meeting;
identifying, by a sidebar assistant, one or more keywords in an audio stream from the second set of audio and video streams corresponding to the sidebar meeting; and
generating, by the sidebar assistant, a note based on the one or more keywords identified in the audio stream from the second set of audio and video streams corresponding to the sidebar meeting.

9. The method of claim 8, wherein identifying, by the sidebar assistant, the one or more keywords in the audio stream from the second set of audio and video streams comprises:
performing, by a computing device, speech recognition on the audio stream from the second set of audio and video streams to identify one or more recognized words.

10. The method of claim 9, wherein:
performing, by the computing device, speech recognition on the audio stream from the second set of audio and video streams comprises transcribing, by the computing device, the audio stream from the second set of audio and video streams to generate a transcription of the audio stream; and
identifying, by the sidebar assistant, the one or more keywords in the audio stream from the second set of audio and video streams corresponding to the sidebar meeting comprises identifying, by the sidebar assistant, the one or more keywords from the transcription.

11. The method of claim 8, further comprising determining, by the sidebar assistant, one or more functions to invoke based on the one or more keywords.

12. The method of claim 11, wherein the one or more functions comprises a recording function, and the method further comprises:
recording, by the sidebar assistant, a segment of the first set of audio and video streams from the main meeting, responsive to determining, by the sidebar assistant, to invoke the recording function based on the one or more keywords; and
generating, by the sidebar assistant, a recording note based on the segment of the first set of audio and video streams recorded.

13. The method of claim 11, wherein the one or more functions comprises a note function, and the method further comprises:
transcribing, by the sidebar assistant, a segment of the audio stream from the second set of audio and video streams corresponding to the sidebar meeting, responsive to determining, by the sidebar assistant, to invoke the note function based on the one or more keywords; and
generating, by the sidebar assistant, the note based on the segment of the audio stream from the second set of audio and video streams transcribed.

14. The method of claim 11, wherein the one or more functions comprises a task function, and the method further comprises:
generating, by the sidebar assistant, a task note, responsive to determining, by the sidebar assistant, to invoke the task function based on the one or more keywords.

15. A non-transitory computer-readable medium comprising processor-executable instructions configured to cause one or more processors to:
establish a video conference having a plurality of participants;
receive, from a first client device, a request for a sidebar meeting;
transmit to the first client device:
a first set of audio and video streams corresponding to a main meeting; and
a second set of audio and video streams corresponding to the sidebar meeting;
identify, by a sidebar assistant, one or more keywords in an audio stream from the second set of audio and video streams corresponding to the sidebar meeting; and
generate, by the sidebar assistant, a note based on the one or more keywords identified in the audio stream from the second set of audio and video streams corresponding to the sidebar meeting.

16. The non-transitory computer-readable medium of claim 15, wherein the processor is configured to execute further processor-executable instructions stored in the non-transitory computer-readable medium to:
display in response to generating the note, on the first client device, a sidebar note, wherein the sidebar note comprises notes generated by the sidebar assistant.

17. The non-transitory computer-readable medium of claim 16, wherein the processor is configured to execute further processor-executable instructions stored in the non-transitory computer-readable medium to:
transmit, to the first client device, a notification that the main meeting is terminated;
terminate transmission, to the first client device, the first set of audio and video streams corresponding to the main meeting; and
transmit, to the first client device, the sidebar note, wherein the sidebar note comprises the note generated by the sidebar assistant.

18. The non-transitory computer-readable medium of claim 15, wherein the processor is configured to execute further processor-executable instructions stored in the non-transitory computer-readable medium to:
receive, from the first client device, an indication to exit the sidebar meeting;
terminate transmission, to the first client device, the second set of audio and video streams corresponding to the sidebar meeting; and
display, on the first client device, the note as part of a sidebar note.

19. The non-transitory computer-readable medium of claim 15, wherein the processor is configured to execute further processor-executable instructions stored in the non-transitory computer-readable medium to:
responsive to generating, by the sidebar assistant, the note based on the one or more keywords, record, by the sidebar assistant, a segment of the first set of audio and video streams corresponding to the main meeting, wherein the segment of the first set of audio and video streams recorded corresponds to a time that the one or more keywords were identified by the sidebar assistant.

20. The non-transitory computer-readable medium of claim 15, wherein the processor is configured to execute further processor-executable instructions stored in the non-transitory computer-readable medium to:
provide, by the sidebar assistant, a timestamp based on the note, wherein the timestamp corresponds to a time in the main meeting when the one or more keywords were identified.
